(19) United States
(12) Patent Application Publication
(10) Pub. No.: US 2010/0088501 A1
(43) Pub. Date: Apr. 8, 2010

(54) Post speedup in oprom systems with intervention support

(75) Inventor: Richard A. Bramley, JR., Mansfield, MA (US)

Correspondence Address: PHOENIX TECHNOLOGIES LTD., 915 MURPHY RANCH ROAD, MILPITAS, CA, 95035, US

(73) Assignee: PHOENIX TECHNOLOGIES LTD

(21) Appl. No.: 12/286,925

(22) Filed: Oct. 2, 2008

(51) Int. Cl. G06F 9/24

(52) U.S. Cl. 713/2

(57) ABSTRACT

Techniques related to personal computers and devices sharing similar architectures are disclosed. Particularly shown is a system and method for enabling improved computer initialization speed achieved by methods including causing apparently premature timeouts when fruitlessly waiting for human intervention.

### FIELD OF THE INVENTION

The present invention generally relates to personal computers and devices sharing similar architectures and, more particularly, to a system and method for enabling improved startup and initialization performance in personal computers.

### BACKGROUND OF THE INVENTION

Modernly, usage of PCs (personal computers) is quite commonplace, yet still growing. Affordable hardware becomes faster and has more capabilities and capacities with each passing year. Application software to handle new tasks and system software to handle new devices continues to emerge.

A typical user may encounter new versions of software that is already deployed with both advantages and disadvantages as compared with the old. It is fair to say that as time passes a typical user deploys a computer of ever more capabilities and increasing amounts of software.

A perennial problem facing the typical computer user is the computer start-up time. Computer start-up time can easily become irritating to a user who merely wishes to get on with the task at hand. Hardware components that are not present in every version of a computer product are known as options and often have start-up code unique to the option. This can be implemented as a so-called option-ROM (Read-Only Memory) which is closely tied to the optional hardware feature itself. Typically an option-ROM may have provision for (human) user intervention such as for purposes of configuration etc. Too often such provisions for intervention fail to be implemented in a way that such provision for human intervention may avoid adding delay to startup.

### SUMMARY OF THE INVENTION

Accordingly, the present invention provides a method for initializing a computer having option-ROM(s) with instructions related to the option encoded therein. Inventive methods may include detecting the option-ROM(s) and passing control to them. Later when the option-ROM(s) query keyboard such as to allow human intervention, a timeout may be caused prematurely so as to avoid delay.

Several variants of these aspects are also discussed together with alternative exemplary embodiments. The disclosed improved designs for firmware and/or software enable superior tradeoffs in regards to the problems outlined above, and more.

### BRIEF DESCRIPTION OF THE DRAWINGS

The aforementioned and related advantages and features of the present invention will become better understood and appreciated upon review of the following detailed description of the invention, taken in conjunction with the following drawings, which are incorporated in and constitute a part of the specification, illustrate an embodiment of the invention and wherein like numerals represent like elements, and in which:

FIG. 1 is a schematic block diagram of an electronic device configured to implement a computer program product and/or method for initializing a computer according to an embodiment of the present invention;

FIG. 2 is a flow chart illustrating the steps performed by the electronic device when implementing an embodiment of the invention;

FIG. 3 is a flow chart illustrating in some detail further steps performed when implementing one exemplary embodiment of the invention;

FIG. 4 is a flow chart illustrating in some detail the steps performed when implementing an interrupt service routine in one exemplary embodiment of the invention;

FIG. 5 shows how an exemplary embodiment of the invention may be encoded onto a computer medium or media;

FIG. 6 shows how an exemplary embodiment of the invention may be encoded, transmitted, received and decoded using electro-magnetic waves.

### DETAILED DESCRIPTION OF THE PREFERRED EMBODIMENTS

In the following description, for purposes of clarity and conciseness of the description, not all of the numerous components shown in the schematics and/or drawings may be described. The numerous components are shown in the drawings to provide a person of ordinary skill in the art a thorough, enabling disclosure of the present invention. The operation of many of the components would be understood and apparent to one skilled in the art. The description of well known components is not included within this description so as not to obscure the disclosure or take away or otherwise reduce the novelty of the present invention and the main benefits provided thereby.

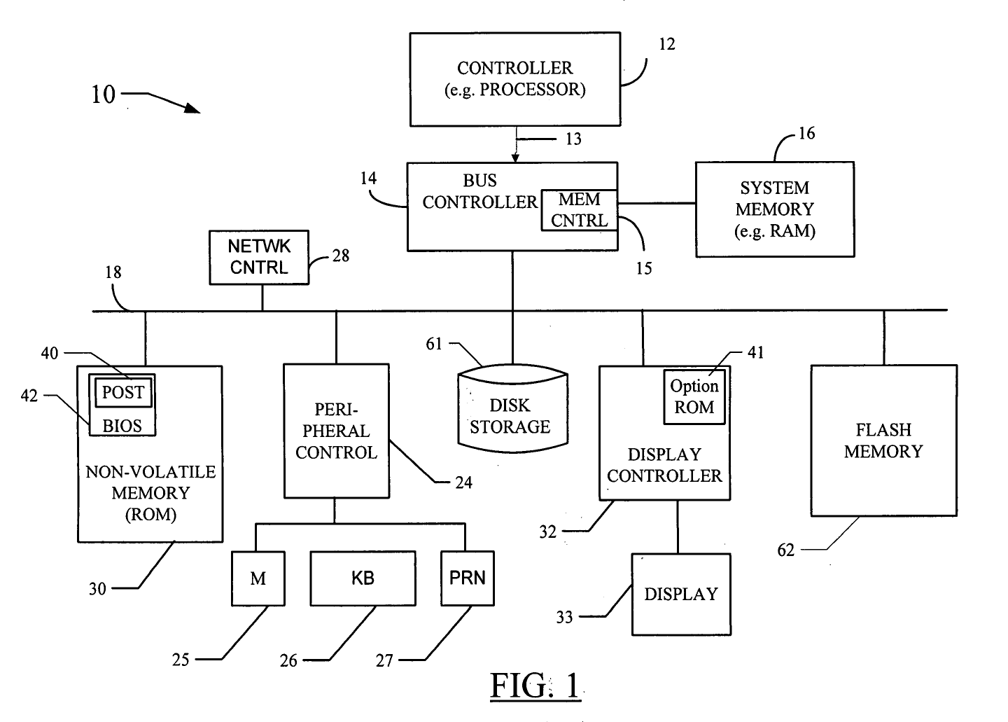

An exemplary embodiment of the present invention will now be described with reference to FIG. 1. FIG. 1 is a schematic block diagram of an electronic device implementing the memory usage functionality according to the present invention. In an exemplary embodiment, the electronic device 10 is implemented as a personal computer, for example, a desktop computer, a laptop computer, a tablet PC or other suitable computing device.

Although the description outlines the operation of a personal computer, it will be appreciated by those of ordinary skill in the art, that the electronic device 10 may be implemented as a PDA, wireless communication device, for example, a cellular telephone, embedded controllers or devices, for example, set top boxes, printing devices or other suitable devices or combination thereof and suitable for operating or interoperating with the invention.

The personal computer 10 may include at least one controller or processor 12, configured to control the overall operation of the electronic device 10. Such a processor or controller is often termed a CPU (Central Processing Unit) or an MPU (Microprocessor Unit). The processor 12 may include an ALU (arithmetic/logic unit) for performing computations, one or more registers for temporary storage of data and instructions, and a sequencer or controller for controlling the operations of the personal computer 10. In one embodiment, the processor 12 may include any of the Celeron® and Centrino™ microprocessors manufactured by Intel® Corporation, or the Power-PC® processor marketed by International Business Machines®. In addition, any of a variety of other processors, including those from Sun Microsystems®, MIPS®, NEC®, Cyrix® and others may be used for implementing the processor 12. The processor 12 is not limited to microprocessors, but may take on other forms such as microcontrollers, digital signal processors, dedicated hardware e.g. ASIC (application-specific integrated circuit), state machines or software executing on one or more processors distributed across a network.

The processor 12 may be coupled to a bus controller 14 by way of a CPU bus 13. The bus controller 14 may include a memory controller 15 integrated therein. In an alternate embodiment, the memory controller 15 may be separate from the bus controller 14. The memory controller 15 may provide an interface for access by the processor 12 or other devices to read-write system memory 16, for example RAM (random access memory).

The bus controller 14 may be coupled to a system bus 18, for example a PCI (peripheral component interconnect) bus. Coupled to the system bus 18 may be a peripheral device controller 24 also known as an I/O (input/output) controller. In turn peripheral device controller 24 is coupled to various other devices such as keyboard 26, mouse 25, printer 27 or other suitable devices. Coupled to the system bus 18 may also network controller 28, disk storage 61 and a display controller 32 coupled to a display 33, and a flash memory 62, and more.

Other components (not shown in FIG. 1) are likely to be present, for example digital audio components would be commonplace.

Although firmware and software may be stored in non-volatile memories, it is commonly transferred to system memory 16 prior to execution by means of a block-oriented device driver or by a shadow-memory technique as is well-known in the art. Exceptionally, instructions, especially POST (Power on self test) or initialization instructions used for early computer setup may be executed directly out of ROM or other suitable non-volatile memory, such as instructions used to implement the shadow-memory operation itself.

As shown, non-volatile memory 30 may contain firmware such as a BIOS 42 (Basic Input-Output System) which may contain a POST 40. Non-volatile memory 30 may contain instructions (firmware and software) for carrying out the steps or acts described below with reference to other figures below. Those steps or acts may correspond to the inventive concept in at least some embodiments.

Additionally, there may be one or more Option-ROMs 41 which will typically, but not essentially, be part of a Controller with which it is associated. In FIG. 1. Option-ROM 41 is shown contained within Display Controller 32, this would be a typical such placement for an Option-ROM.

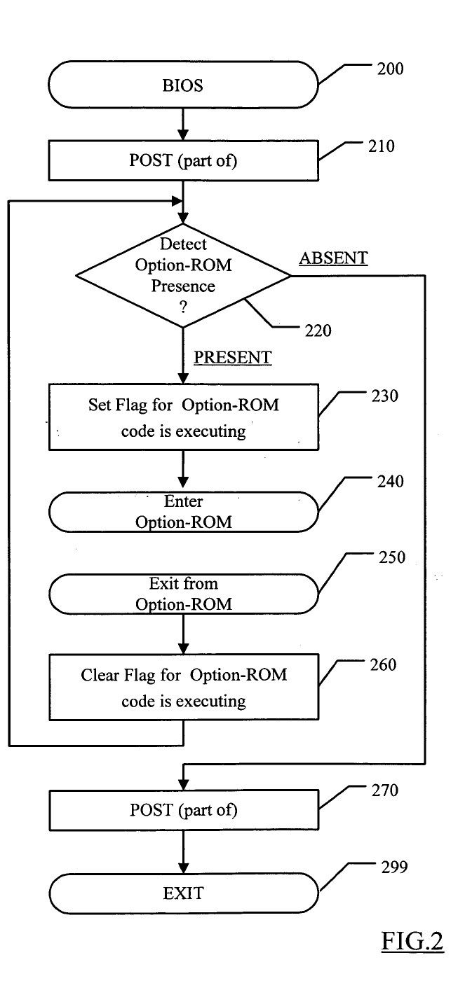

FIG. 2 is a flowchart illustrating the steps performed by the electronic device when implementing an improved start-up process with the present invention beginning from an entry point 200 within the device's BIOS which is well-known to be typically embodied as firmware. In the exemplary embodiment such firmware many be contained within a non-volatile memory (such as memory 30 in FIG. 1.) Returning to FIG. 2, at box 210 a first part of POST may be executed.

At box 220 an attempt is made to detect the presence of an option-ROM (such as Option-ROM 41 in FIG. 1.). As a person of ordinary skill in the art will observe BIOS can find and exploit option-ROM through an iterative process. Typically, but not necessarily, option-ROMs may be found in the C000:0 through D000:FFFFh address range. Depending on the BIOS, the ending address may be higher. Offsets 0000h-0001h of the option-ROM may be a distinct signature bit pattern, offset 0002h may typically be the size of the option-ROM in 512 byte units and offset 0003h may typically be an address that is called to initialize the option-ROM.

Any device that needs to be used for boot could reasonably have an option-ROM (network, video, SCSI (small computer system interface). An option-ROM extends a standard BIOS function in order to allow the device to be used as desired. The option-ROMs typically found may include video, SCSI and RAID (controllers for redundant arrays of inexpensive disks).

Returning to box 220, if no option-ROM can be detected, typically either because there is none present or because they have all been previously discovered through exhaustive iteration, then control passes to box 270 where the remainder of the POST is executed and the method is completed at box 299.

In the case that an option-ROM is detected then at box 230, a flag is set to indicate that “option-ROM code is executing”. As described below, the usage of this flag may be a part of the present invention. More precisely, the flag is set immediately prior to entering option-ROM code (and is later cleared shortly after exiting option-ROM code) but for practical purposes the term “option-ROM code is executing” is succinct and a sufficiently accurate description. At step 240 the option-ROM is entered, typically at its own detected entry address.

During execution of instructions in the option-ROM (not shown in FIG. 2) there may be caused interrupts and associated processing as discussed below in connection with other figures.

Upon return from option-ROM processing (box 250) the flag to indicate “option-ROM is executing” may be cleared (box 260). In alternative embodiments of the present invention a separate flag may be used or substantially equivalent implementations will be obvious to a person of ordinary skill in the art. Control is then returned to box 220 to continue the iterated search for further option-ROMs.

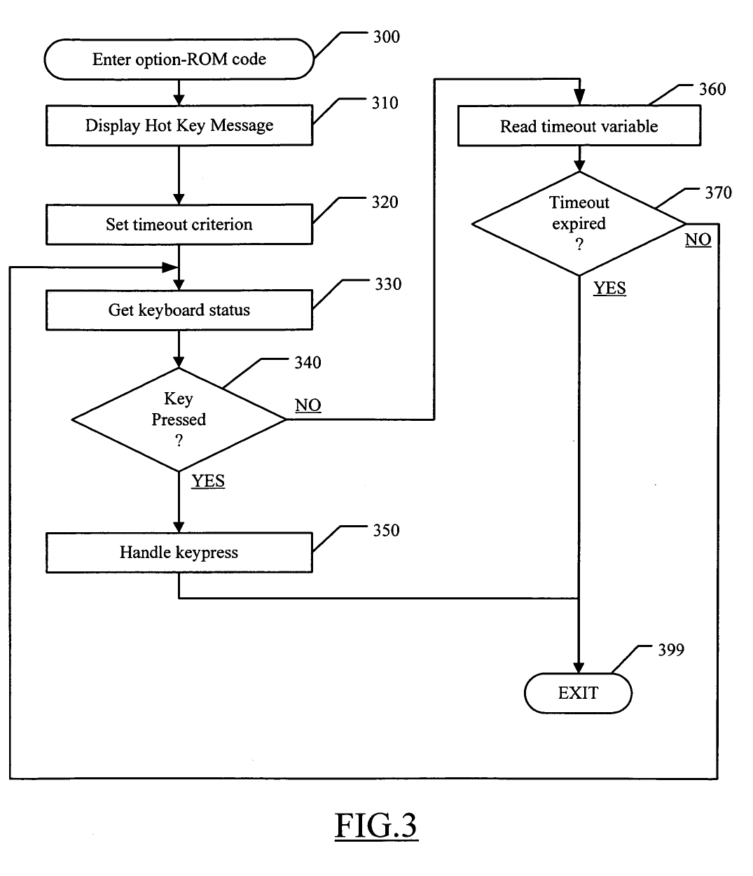

Referring now to FIG. 3 which is a flow chart illustrating in some detail some of the processing that may typically be found inside option-ROM code itself performed when implementing one exemplary embodiment of the invention. It may be advantageous to embody the invention without revision of the contents of option-ROM since any revision thereof may be difficult or raise support or other practical issues.

At entry box 300, the option-ROM code is entered and may perform various initialization and other operations.

Option-ROMs may typically display a message indicating that the user can press a hot key to invoke the configuration menu and default behavior may then be to wait some amount of time while checking to see if the user has pressed a key. Assuming the user doesn't hit a key within a certain amount of time the option-ROM exits and control returns to the BIOS to continue booting. For 99% of the bootload instances this timeout simply lengthens the boot time. In an embodiment of the invention that default behavior may be modified as described herein. Thus, at box 310, such a “Hot Key” message may be displayed. Then at box 320 a timeout criterion may be set.

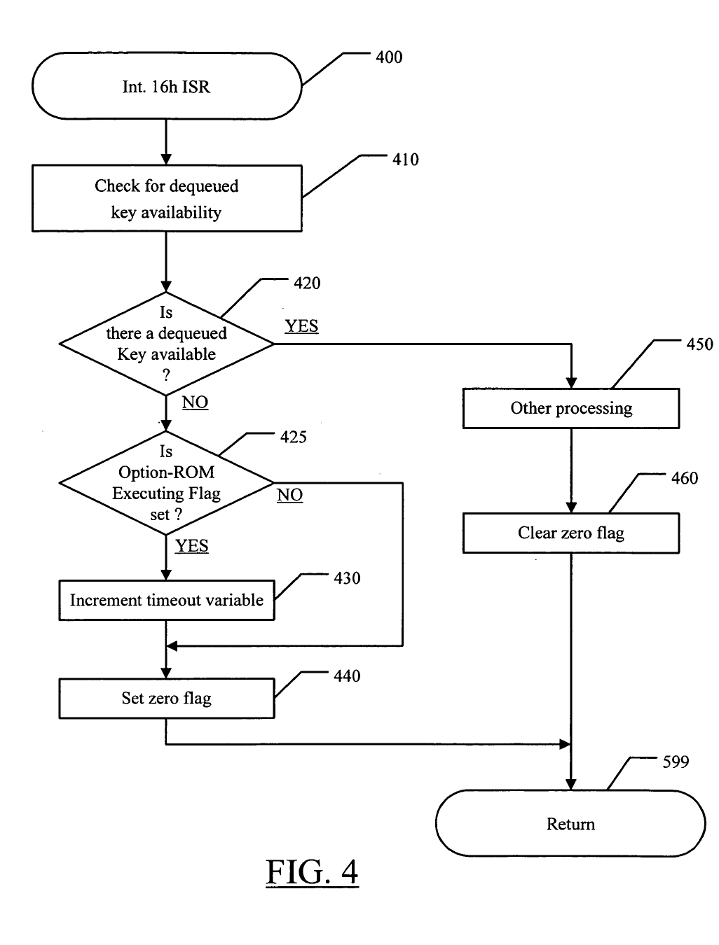

Box 330 begins an iterative loop. In previously developed solutions, a purpose of this iteration may be to provide an opportunity for human intervention. At 330, the firmware may obtain keyboard status such as by creating a “software” interrupt to invoke a service routine such as that described in connection with FIG. 4. Still referring to FIG. 3, at 340, a check is made as to whether there is human intervention by way of a key depression. In other embodiments other substantially similar mechanisms may be used in substitute. If there is a key depression then the keypress is handled at box 350 and at box 399, exit is made from the option-ROM. In alternative embodiments (not shown in FIG. 3) further substantially unrelated processing may occur before the code of the option-ROM is exited at 399.

In the alternative, if there is no key depression then at box 360, a timeout variable is read and checked for expiry (box 370). As explained below in connection with FIG. 4, a timeout may be premature or timely according to ISR (interrupt service routine) implementation. Assuming the timeout has not occurred then control is transferred back to 330, above.

FIG. 4 is a flow chart illustrating in some detail the steps performed when implementing an ISR in one exemplary embodiment of the invention. In an embodiment of the invention the key service software interrupt may be entered by Interrupt 16 (Hexadecimal) commonly expressed as “Int.16h”. At box 400, the ISR is entered.

A typical ISR may have many steps and branches not shown in FIG. 4 and which may typically be selected by setting entry parameters, such as through the well-known AH register found in commonplace X86 type processors. In box 410 a test may be made as to whether a dequeued key (i.e. a data code representing a key press and which may be retrieved from a memory queue) has become available. In box 420, a decision may be made; if there is no dequeued key then a further check is made, at box 425, as to whether the Option-ROM is executing Flag is set. If that Flag is set then the Option-ROM may be presumed to be executing and therefore at box 430 a timeout variable may be incremented. Such action would not be expected in previously developed code solutions dealing with key dequeueing but rather in relevant timer code (i.e. elsewhere). The effect may be to move towards, or indeed actually make incipient or cause, a premature timeout condition in the calling code (See description of FIG. 3, above). If, at box 425, it is determined that the Option-ROM is executing Flag is clear then control simply passes to box 440 without incrementing the timeout variable.

As is customary for no-key situations a “Zero flag” may be set (box 440) to provide return status. Absent the adjustment to timeout variable (or substantially equivalent feature) then timeouts would be timely rather than premature, as in previously developed solutions.

In contrast, if at box 420, a dequeued key is in fact available then control is passed to code which may pre-process it (box 450) and at box 460 the “zero flag” may be cleared so that on return from interrupt the dequeued key may be detected and processed outside the ISR context. At box 599, exit from the ISR may be made, such as through the well-known RETI instruction.

With regards to FIG. 5, computer instructions in an electronic device 12 may be distributed as manufactured firmware and/or software computer products 510 using a variety of possible media 530 having the instructions recorded thereon using a storage recorder 520. Often in products as complex as those that deploy the invention, more than one medium may be used, both in distribution and in manufacturing relevant product. Only one medium is shown in FIG. 5 for clarity but more than one medium may be used and a single computer product may be divided among a plurality of media.

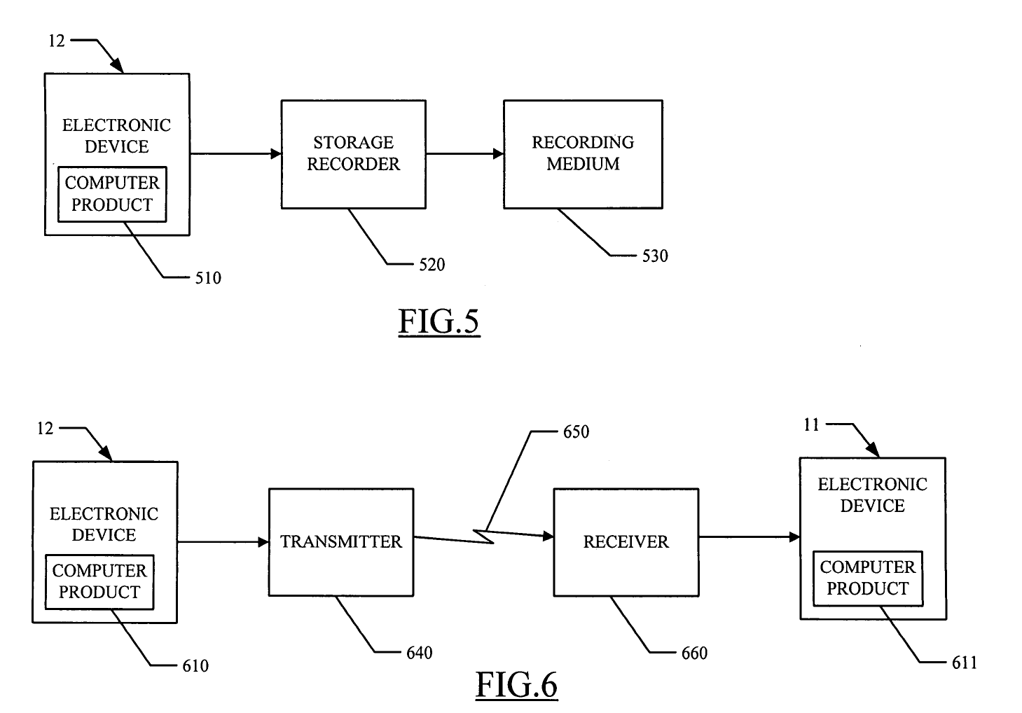

With regard to FIG. 6, additionally, and especially since the rise in Internet usage, computer products 610 may be distributed by encoding them into signals modulated as a wave. The resulting waveforms may then be transmitted by a transmitter 640, propagated as modulated electromagnetic carrier waves 650 and received by a receiver 660. Upon reception they may be demodulated and the signal decoded into a further version or copy of the computer product 611 in a memory or storage device 11.

Other topologies and/or devices could also be used to construct alternative embodiments of the present invention. In particular, an option-ROM is not always implemented as a discrete device; rather it may be an additional section of a more general purpose ROM (typically a ROM containing BIOS code).

The embodiments described above are exemplary rather than limiting and the bounds of the invention should be determined from the claims. Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A method for initializing a computer comprising steps of:
detecting a presence of an option-ROM (Read-Only Memory) having a plurality of instructions encoded in the option-ROM;
passing control to the instructions; and
responsive to a request implemented by a portion of the instructions, causing a premature timeout condition or a premature incipient timeout condition.

2. The method of claim 1 wherein
the request is a keyboard status inquiry.

3. The method of claim 2 wherein
the request is an interrupt based keyboard status inquiry.

4. The method of claim 1 wherein
the request is an interrupt.

5. The method of claim 1 wherein
the request is an interrupt type 16h, AH=01h based check keyboard status request.

6. The method of claim 1 wherein
the request is a debug register trap to a timing resource.

7. The method of claim 1 wherein
the causing is an incrementing or decrementing of a BIOS (Basic Input-Output System) timer variable.

8. The method of claim 1 wherein
the causing is an advancing of an ACPI (Advanced Configuration and Power Interface specification) variable.

9. A method for initializing a computer comprising steps of:
recording a first status to indicate a commencement of an execution of a plurality of instructions encoded in an option-ROM;
commencing the execution;
responsive to detecting the first status,
causing a premature timeout condition or a premature incipient timeout condition; and
responsive to detecting an execution of an exit instruction comprised within the plurality of instructions encoded in the option-ROM,
changing the first status into a second status to indicate an end to the execution of the plurality of instructions encoded in the option-ROM.

10. A computer-readable medium having computer instructions encoded thereon, the instructions when executed by at least one computer cause said at least one computer to become initialized by steps comprising the acts of:
detecting a presence of an option-ROM (Read-Only Memory) having a plurality of instructions encoded in the option-ROM;
passing control to the instructions; and
responsive to a request implemented by at least some of the instructions, causing a premature timeout condition or a premature incipient timeout condition.

11. A method comprising:
an act of modulating a signal onto an electromagnetic carrier wave impressed into a tangible medium, or demodulating the signal from the electro-magnetic carrier wave, the signal having computer instructions encoded therein, the instructions when executed by at least one computer causing said at least one computer to
become initialized by steps comprising the acts of:
detecting a presence of an option-ROM (Read-Only Memory) having a plurality of instructions encoded in the option-ROM;
passing control to the instructions; and
responsive to a request implemented by at least some of the instructions, causing a premature timeout condition or a premature incipient timeout condition.

12. A method for initializing a computer comprising
means for detecting a keyboard status inquiry; and
BIOS-based means for causing a premature timeout condition or a premature incipient timeout-condition responsive to the detecting.

13. An electronic device comprising:
at least one controller or CPU (central processor unit); and
a non-volatile memory having computer instructions encoded therein, the instructions when executed by the controller or CPU cause said controller or CPU to
become initialized by steps comprising the acts of:
detecting a presence of an option-ROM (Read-Only Memory) having a plurality of instructions encoded in the option-ROM;
passing control to the instructions; and
responsive to a request implemented by at least some of the instructions, causing a premature timeout condition or a premature incipient timeout condition.
